(19) United States
(12) Patent Application Publication
(10) Pub. No.: US 2003/0130972 A1
(43) Pub. Date: Jul. 10, 2003

(54) Learning by knowledge division into atoms and combination of atoms into payoffs

(76) Inventor: Laurence E. Holt, London (GB)

Correspondence Address: LAW OFFICES OF MICHAEL DRYJA, 704 228TH AVENUE NE, PMB 694, SAMMAMISH, WA, 98074, US

(21) Appl. No.: 09/683,506

(22) Filed: Jan. 10, 2002

(51) Int. Cl. G06N 5/00; G06F 17/00; G06F 15/00; G06F 15/18

(52) U.S. Cl. 706/45

(57) ABSTRACT

A learning technology is disclosed. To prepare knowledge to be learned, the knowledge is divided into a number of atoms. Each atom is a quickly learned and combinable unit of the knowledge. A number of payoffs of combinations of at least some of the atoms is arranged. Each payoff yields an insight into the knowledge directly unfounded in the atoms themselves. Tests are devised to be given periodically and repeatedly to reinforce the knowledge learned. To learn knowledge, a number of atoms are learned, and then a payoff of a combination of these atoms is learned. Repeated testing of the atoms and the payoff is preferably performed to reinforce the knowledge gained. The invention can be embodied as an article of manufacture having media, and learning material in the media. The media may include books, other written materials, optical media storing computer programs, Internet web sites, and so on.

### BACKGROUND OF INVENTION

This invention relates generally to learning technologies, and more particularly to simplified learning technologies.

In their jobs and for personal reasons, people are expected to or want to learn more. A computer programmer thirty years ago, for example, may have learned one or two computer programming languages and one or two programming methodologies that the programmer expected to last him or her throughout his or her career. Today, however, the computer programmer is expected to learn new programming languages as they become relevant to his or her job, as well as learn new programming paradigms in which to implement these new programming language skills. Similarly, people are learning foreign languages, new cooking techniques, and other skills for personal enrichment, more so than they have done in the past.

Traditionally, learning has been performed in the classroom. During a person's school age years, he or she learns on a full-time basis, going to class, reading textbooks, and so on. Whereas this type of learning has been proven by the test of time to be effective, it is nevertheless inefficient. Adults with day jobs cannot be expected to go back to school every time a new skill presents itself that needs to be learned. Furthermore, going to school is expensive, and thus is a luxury that many younger people and senior citizens who wish to learn new interests for personal enrichment cannot afford.

More recently, there has been a marked increase in the number of learning aids that people can buy to learn new skills for personal and professional reasons. These learning aids come in a number of different forms, such as books and computer software on optical media like CD-ROM's and DVD-ROM's. Many people have found it difficult to learn material from such learning aids, however, through no fault of their own.

Such learning materials have a tendency to lecture, covering too much theory too quickly. They divide topics down in a referential manner and structure that may make sense to experts in the field, but not to beginners approaching the subject for the first time. The materials provide few opportunities to practice their newly acquired knowledge, and frequently separate these opportunities from the main text as exercises, almost encouraging the reader to skip them. The learning aids confuse simplicity for brevity, when in many cases these are opposites.

Furthermore, classroom learning suffers from the same problems as these other learning techniques. Usually too much theory is presented in the classroom. Students may not absorb much of the material being lecture on by the teacher or professor. Students also have little time or experience with practical applications of the knowledge being taught, or otherwise practicing the knowledge. To at least some extent, classroom learning is an exercise in crowd control, attempting to keep students focused on the lesson at hand by keeping it active and interesting, as opposed to ensuring that the students are actually learning.

To prevent students from suffering from low self esteem, many teachers and professors also give wide latitude in what is considered an acceptable answer on a test. While this may ensure that the student does not have a negative experience, it does affect the student's ability to combine the knowledge learned with new knowledge in the future. Thus, the student may be told that he or she knows the subject matter being taught, when in actuality little or no mastery has been achieved. For these and other reasons, therefore, there is a need for the present invention.

### SUMMARY OF INVENTION

The invention relates to a simplified learning technology. To prepare knowledge to be learned, the knowledge is divided into a number of atoms. Each atom is a quickly learned and combinable unit of the knowledge. A number of payoffs of combinations of at least some of the atoms are arranged. Each payoff yields an insight into the knowledge directly unfounded in the atoms themselves. Tests are also preferably but not necessarily devised to be given periodically and repeatedly to reinforce the knowledge learned.

To learn knowledge, a corresponding process is followed. First, a number of atoms are learned, and then a payoff of a combination of these atoms is learned, which yields an insight into the knowledge directly unfounded in the atoms themselves. Repeated testing of the atoms and the payoff also preferably reinforces the knowledge gained. The invention can be embodied as an article of manufacture having one or more media, and learning material in the media. The media may include books or other written materials, optical media such as CD-ROM's and DVD-ROM's storing computer programs, as well as Internet web sites.

Embodiments of the invention provide for advantages not found within the prior art. Significantly, the technique for learning of the invention is dramatically more efficient than learning techniques of the prior art. Students first master some easily learned atoms of knowledge, which are then combined into payoffs to sustain interest in the subject matter being learned, and which provide insight into the subject matter. Such payoffs yield what video game designers call game play, the balance between effort and reward that enhances learning. Still other advantages, aspects, and embodiments of the invention will become apparent by reading the detailed description that follows, and by referencing the accompanying drawings.

### BRIEF DESCRIPTION OF DRAWINGS

FIG. 1 is a flowchart of a method for preparing knowledge in order for the knowledge to be learned by a student, according to the simplified learning technology of an embodiment of the invention.

FIG. 2 is a flowchart of a method for learning knowledge that has been prepared, according to the simplified learning technology of an embodiment of the invention.

FIG. 3 is a flowchart of a method showing application of the simplified learning technology according to an embodiment of the invention as to learning how to predict weather.

FIG. 4 is a flowchart of a method showing application of the simplified learning technology according to an embodiment of the invention as to learning how sailboats sail into the wind.

FIG. 5 is a flowchart of a method showing application of the simplified learning technology according to an embodiment of the invention as to learning how to recognize a constellation in the night sky.

FIG. 6 is a flowchart of a method showing application of the simplified learning technology according to an embodiment of the invention as to learning how to play a musical instrument, such as a guitar.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

The detailed description of the invention is divided into sub-sections as follows. First, the simplified learning technology is described without reference to a particular example of knowledge. The learning technology is described both by how it enables the preparation of knowledge to be efficiently learned, as well as how it enables the learning of such knowledge that has been so prepared. The learning technology itself can be embodied as an article of manufacture having one or more media and learning materials in the media. The media may include books, other written materials, optical media such as CD-ROM's and DVD-ROM's storing computer programs, Internet web sites, and so on. Such media may be used alone or together.

The detailed description of the invention next includes a number of sub-sections giving specific examples of knowledge and learning topics that have been divided per the simplified learning technology previously described. These examples are provided to give insight into how the technology can be implemented and used. However, they are examples only, and do not represent limitations as to the types of knowledge that can be taught and learned with embodiments of the invention. Finally, the detailed description of the invention concludes with a conclusion sub-section.

Simplified Learning Technology

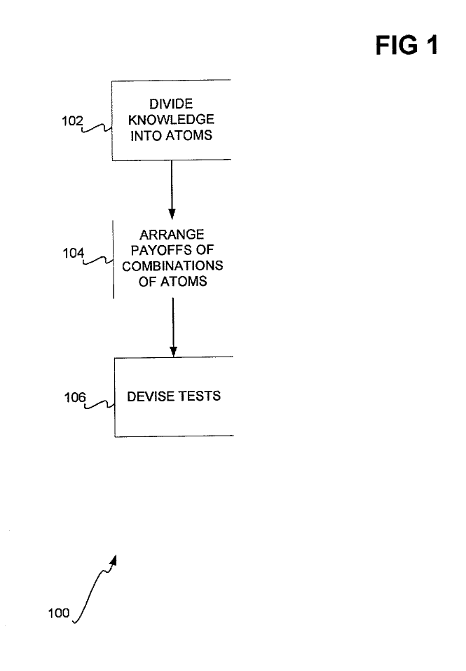

FIG. 1 shows a method 100 for implementing the simplified learning technology of an embodiment of the invention. A body of knowledge to be learned is divided into atoms (102). Each atom is a quickly learned and combinable unit of knowledge, and preferably represents a real-world application of the knowledge unit. An atom should not include explanation of the unit of knowledge, but be the unit of knowledge itself. Preferably, an atom is not conveyed to a student without straightaway testing that he or she has grasped it. For instance, the student may be asked to apply the atom in a different situation than in which it was introduced. Atoms that can be combined are also preferred. For example, the name of the discoverer of a concept, or the name of the concept itself, is not necessary to the understanding of the concept itself, and therefore is preferably not included in an atom. Atoms that are not strictly correct, or that have rare exceptions, can also be devised. The exceptions should not be explained until the atom is thoroughly understood, if at all. Furthermore, the explanation of an atom is preferably delayed until it has been assimilated such that the student can apply it unaided.

Next, the atoms are combined into payoffs (104), where each payoff yields an insight into the knowledge that is not directly founded in the atoms themselves. A payoff may be a sequence of atoms such that combining them delivers an insight designed to sustain interest. However, too frequent payoffs may devalue them, whereas too infrequent payoffs may mean that the student loses interest in the knowledge being learned. The payoff should be valuable in that it conveys excitement of achievement, even though the student may not be able to ascertain whether the payoff is in fact a valuable insight. A payoff can be the recognition by the student that he or she is learning something or able to do something that the student did not know or could not do before. The simplified learning technology may assume some initial appetite on the part of the student for learning, but the payoffs are meant to strengthen and increase that appetite.

Finally, tests of the knowledge are devised that are given periodically and repeatedly (106), to reinforce the knowledge learned. Preferably, most of the learning time is spent testing what the student already knows, ideally just before the student forgets the knowledge. For simple topics, such as knowledge atoms, the test may be performed with decreasing periodicity for example, first after a day that the atom was learned, then a week after, then a month after, such that the student then has the atom committed to memory. Tests may be combined with new atoms to ensure payoffs in testing as well. This may be achieved by combining testing with new atoms that are combined with the old ones being tested, so that each learning session combines testing the retention of atoms from a previous session, with learning new atoms. The testing thus reinforces the previous learning that has occurred.

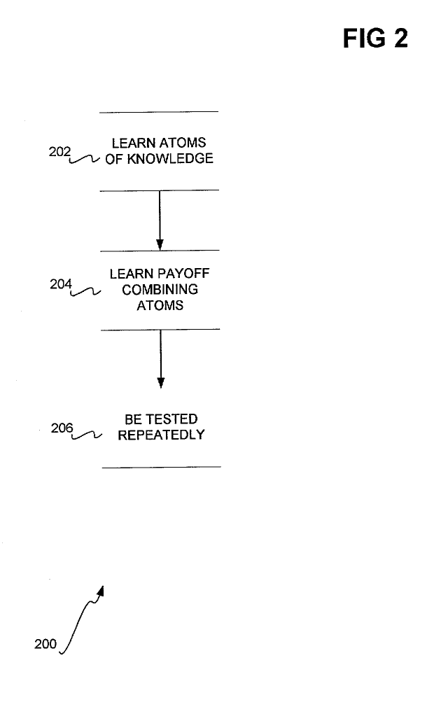

Furthermore, the testing performed is preferably strict, in that a student should not be allowed a wide margin for error. This is as compared to the prior art, where teachers and professors often allow students to have a wide margin for error to avoid the students losing their self esteem by having a negative experience. However, since atoms are preferably designed to be easily assimilated, no such wide margin is necessary, and is in fact detrimental, because if a student is being sloppy with his or her newly gained knowledge, the student cannot be expected to retain the knowledge accurately or combine it with new knowledge atoms in the future.

Whereas FIG. 1 shows a method 100 that illustrates how knowledge can be prepared in accordance with the simplified learning technology of an embodiment of the invention, FIG. 2 shows a method 200 that illustrates how this knowledge, once prepared, can be taught in accordance with the learning technology of an embodiment of the invention. The method 200 thus substantially corresponds to the method 100, and the description of the method 100 relates to the method 200 as well. First, a student learns atoms of knowledge (202). The student then learns a payoff that combines these atoms (204), and finally is tested repeatedly and periodically (206). This process is repeated with new atoms and new payoffs to further introduce other parts of the knowledge that the student is to learn.

### EXAMPLE

### How to Forecast Weather

Beginning with this sub-section of the detailed description, a number of examples of the simplified learning technology that was described generally with reference to FIGS. 1 and 2 are presented. However, these are examples only, and are meant only to illustrate how embodiments of the invention can be implemented, and are not meant to limit the invention to only these examples. For instance, the inventive learning technology may be applied to practical topics, sports topics, business topics, technical topics, health topics, creative topics, as well as other topics that may be of interest to students.

Practical topics may include forecasting the weather, navigating by stars and the sun, cooking, body language, and so on. Sports topics may include sailing, golf, baseball, etc. Business topics can include small company financial tracking, managing people, raising funding, and so on. Technical topics may include learning computer programming languages, computer software applications, and other types of such topics. Health topics might include first aid aimed at parents, selecting a treatment for a chronic disease, etc. Creative topics may include shooting home movies, writing, drawing, and so on.

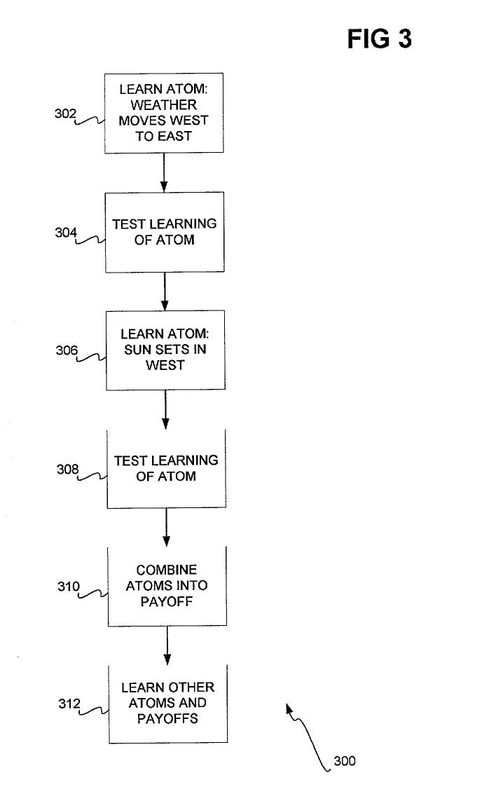

The specific example of this sub-section of the detailed description is forecasting weather. FIG. 3 shows a method 300 for learning such forecasting, according to an embodiment of the invention. First, the atom of knowledge that in the United States and in Europe, weather moves from west to east most of the time, is introduced (302).

A photo or video sequence may be shown that shows clouds moving west to east.

Tests can then be performed (304). For instance, the student may be told that he or she is on the phone with a friend who lives west of the student, and who says it is raining hard. The student is then asked what weather he or she can expect. Another test is for a number of photos looking north, east, south, and west to be shown to the student, and the student asked whether he or she needs to bring an umbrella.

Next, the atom of knowledge that the sun sets in the west is provided (306), perhaps with a picture showing a cowboy riding off into the sunset. This also is tested repeatedly (308), with pictures of the sky, initially showing sunsets, and then cloudy sunsets. Pictures showing the sun rising, which will need to be explained if the student does not know that the sun moves across the sky from dawn to dusk, and then pictures showing mid-day, in which the student should not have an answer, and finally pictures showing full-cloud cover, in response to which the student should also not have an answer, can be provided. Pictures of random situations may also be used.

These atoms are combined into a payoff (310). Sky photos that are not labeled with compass directions are shown, and the student is asked to forecast the weather where the photo was taken. When the student is correct, he or she is congratulated. This process is repeated with other photos. The student might be asked to forecast the weather in the real world, at least once a week. Once the student is comfortable with the basic approach, the atoms learned can be built upon with other atoms, such as fall streaks point to warmer air, and the crosswinds rule, to yield additional payoffs (312). Exceptions where weather moves east to west may also be introduced.

Therefore, this approach does not concentrate on air masses, fronts, or changes in atmospheric pressure, because these concepts cannot be seen, and therefore are of dubious value to learning how to forecast the weather in an amateur manner. Rather than being taught how, for a particular front, clouds change, the student is taught how to spot the front from the cloud sequence, so that he or she can predict the weather that comes next. The inventive approach has the student forecasting weather within minutes, and puts the student in life-like situations to test his or her newly gained knowledge. Explanations, such as why weather moves from west to east, are also omitted, or at least delayed until the student comprehends the atom of knowledge.

### EXAMPLE

### How Sailboats Sail into Wind

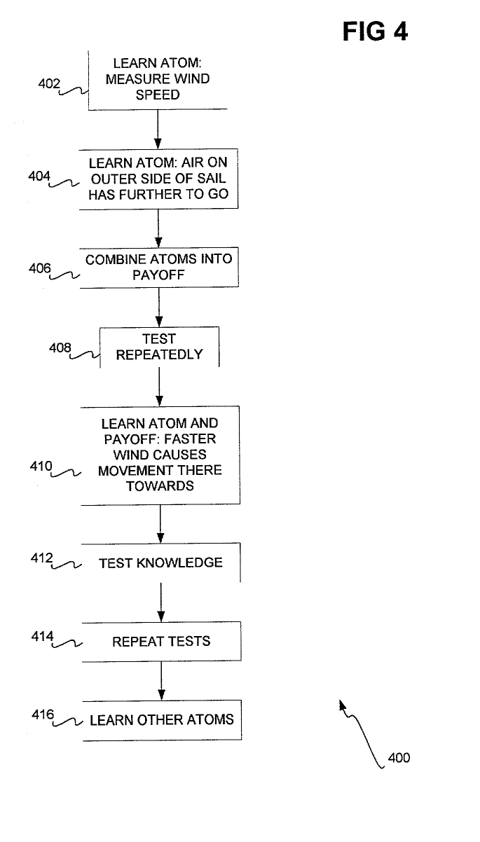

FIG. 4 shows a method 400 of another example of the inventive simplified learning technology, according to an embodiment of the invention, how sailboats sail into the wind. While sailing, the student is handed an anemometer, which measures wind speed (402). The student is asked to measure the wind speed, potentially at different places on the boat. Once the student is comfortable with this task, he or she is asked to measure the wind speed on both sides of the foresail, and is explained the atom of knowledge that air on the outer side of the sail has further to go (404). The student may be asked to measure the wind speed on one side of the main sail, and ask them to predict whether the wind speed on the other side is higher or lower, and then asked to determine if the prediction is correct. Thus, the prediction, when correct, is a payoff in that it combines atoms of knowledge in a way that yields insight to the student (406). At the end of the trip, the student is again asked on which side of the sail the wind is faster. The student should be tested again within a week, such as in a classroom, by phone or email, and so on (408).

On the next sailing trip, the student is asked to place his or her hands in the wind at different angles to feel the different forces. The student's hands should be arranged so that they are at similar angles to the wind as the main sail is close hauled. The student is told that his or her hand moves towards the faster wind, and is explained that the faster wind sucks the hand towards it, similar to getting sucked along behind a truck on the highway, or sucked off a platform when a fast train goes by. Thus, the student is being taught another atom of knowledge, while also being taught a payoff with the previously learned atom of knowledge regarding wind speed (410). The student is then tested, by being asked on which side of the main sail wind is faster, and which direction the boat is being sucked (412). If the student cannot determine the correct answer, he or she is asked to imagine the sail as a big hand. This test is repeated again at the end of the trip, within a week, and then again within a month (414). If the student recalls the knowledge correctly, other atoms can be added (416).

Therefore, this approach does not concentrate on the shape of a sail, Bernoulli's principle, how this principle translates into lift, and so on. These aspects are unnecessary clutter that detract from the student learning the desired subject matter. Concepts such as pressure difference are also not included because they actually do not explain anything, but rather introduce new topics that themselves must be explained. Depending on the objective of the learning taking place, some atoms may be included, and other atoms omitted, to ensure that only learning of the subject matter is advanced.

### EXAMPLE

### Recognizing a Constellation in the Night Sky

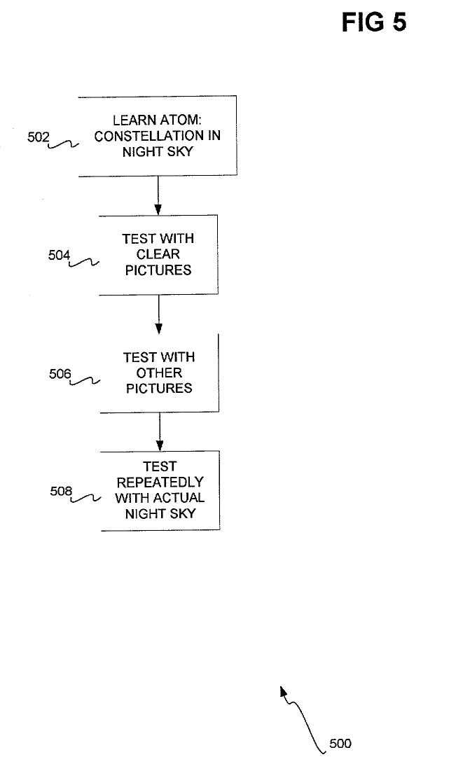

FIG. 5 shows a method 500 of another example of the inventive simplified learning technology, according to an embodiment of the invention, recognizing a constellation in the night sky. An image of the night sky is given to the student, and a constellation is highlighted in the image and named (502). The highlighting is removed, and the student is asked to locate the constellation (504). Once the student can locate the constellation, he or she is shown a sequence of different pictures of the night sky, in different orientations, at different times of year, and so on, and is asked for each picture to find the constellation (506). The process is then repeated with the real sky, at least once a month (508). Thus, this example uses the real sky, or pictures of the real sky, instead of using poorly designed learning aids, such as line drawings of constellations, which are of little value in recognizing constellations in the sky. This is because, once the lines are removed, students typically have trouble recognizing the constellations.

### EXAMPLE

### Learning to Play a Musical Instrument

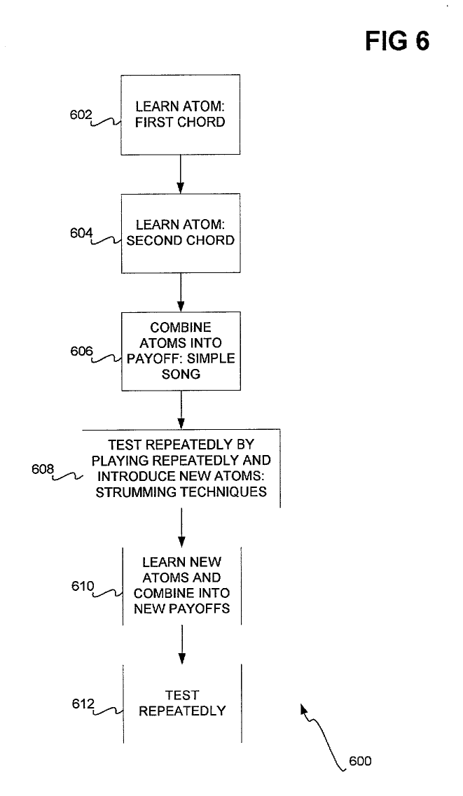

FIG. 6 shows a method 600 of a final example of the inventive simplified learning technology, according to an embodiment of the invention, learning to play a musical instrument, such as a guitar. Usually, a student is first taught to sit correctly, to hold the instrument correctly, to learn correct technique for playing, and then to learn an entire piece that is played over and over again. The inventive approach is for the student to learn a chord that can be played with one finger of the left hand, such as G, which is an atom of knowledge (602). The student then learns another atom of knowledge, such as another simplified chord, like C (604). A payoff combining these two atoms of knowledge is taught to the student, such as a part of a song that includes just these two chords (606). The song is played again, to ensure that the chord changes are smooth, and different strumming patterns are introduced as new atoms of knowledge integrated with the other knowledge atoms to yield new payoffs (608). As time progresses, the student learns new chords, and learns to play new songs, such that new atoms of knowledge and new payoffs are introduced (610), with repetition to ensure that the student retains his or her knowledge (612).

### CONCLUSION

It is noted that, although specific embodiments have been illustrated and described herein, it will be appreciated by those of ordinary skill in the art that any arrangement is calculated to achieve the same purpose may be substituted for the specific embodiments shown. This application is intended to cover any adaptations or variations of the present invention. Therefore, it is manifestly intended that this invention be limited only by the claims and equivalents thereof.

1. A method comprising:
dividing knowledge to be learned into a plurality of atoms, each atom being a quickly learned and combinable unit of the knowledge; and,
arranging a plurality of payoffs of combinations of a sub-plurality of the plurality of atoms, each payoff yielding an insight into the knowledge directly unfounded in the plurality of atoms themselves.

2. The method of claim 1, further comprising devising a plurality of tests of the knowledge to be given periodically and repeatedly to reinforce the knowledge learned.

3. The method of claim 2, wherein each test is combined with a new atom of the plurality of atoms to be learned, to generate a new payoff of the plurality of payoffs to be learned when the test is given.

4. The method of claim 2, wherein the tests are given with decreasing periodicity.

5. The method of claim 1, wherein each atom represents a real-world application of a unit of the knowledge.

6. The method of claim 1, wherein each atom does not include explanation of a unit of knowledge.

7. The method of claim 1, wherein each payoff is designed to sustain interest in learning the knowledge.

8. A method comprising:
learning a number of atoms of a plurality of atoms into which knowledge has been divided, each atom being a quickly learned and combinable unit of the knowledge; and,
learning a payoff of a plurality of payoffs, the payoff being a combination of the number of atoms and yielding an insight into the knowledge directly unfounded in the number of atoms themselves.

9. The method of claim 7, further comprising repeatedly being tested of the number of atoms and the payoff with one or more tests of the knowledge, to reinforce the knowledge learned.

10. The method of claim 8, further comprising repeating learning the number of atoms, learning the payoff, and repeatedly being tested, with a new number of atoms and a new payoff.

11. The method of claim 8, wherein each test is combined with a new atom of the plurality of atoms to be learned, to generate a new payoff of the plurality of payoffs to be learned when the test is given.

12. The method of claim 7, wherein each atom represents a real-world application of a unit of the knowledge.

13. The method of claim 7, wherein each payoff is designed to sustain interest in learning the knowledge.

14. An article of manufacture comprising:
one or more media; and,
learning material in the media to perform a method comprising:
teaching a number of atoms of a plurality of atoms into which knowledge has been divided, each atom being a quickly learned and combinable unit of the knowledge; and,
teaching a payoff of a plurality of payoffs, the payoff being a combination of the number of atoms and yielding an insight into the knowledge directly unfounded in the number of atoms themselves.

15. The article of claim 14, wherein the method further comprises repeated testing the number of atoms and the payoff with one or more tests of the knowledge, to reinforce the knowledge learned.

16. The article of claim 14, wherein the one or more media comprises a book.

17. The article of claim 14, wherein the one or more media comprises an Internet web site.

18. The article of claim 14, wherein the one or more media comprises an optical media on which the learning material is implemented as a computer program.

19. The article of claim 14, wherein each atom represents a real-world application of a unit of the knowledge, and does not include explanation of a unit of knowledge.

20. The article of claim 14, wherein each payoff is designed to sustain interest in learning the knowledge.
